(19) United States
(12) Patent Application Publication
(10) Pub. No.: US 2014/0143350 A1
(43) Pub. Date: May 22, 2014

(54) MANAGING EMAIL FEEDBACK

(71) Applicant: SAP AG, Walldorf (DE)

(72) Inventors: Christian Ortmann, Karlsdorf-Neuthard (DE); Daniela Schlaud, Sandhausen (DE); Bertram Wiest, Heidelberg (DE); Joachim Foerderer, Wiesloch (DE); Mark Thomas Darby, Heidelberg (DE)

(73) Assignee: SAP AG, Walldorf (DE)

(21) Appl. No.: 13/681,304

(22) Filed: Nov. 19, 2012

(51) Int. Cl. G06F 15/16

(52) U.S. Cl. 709/206

(57) ABSTRACT

Solutions are provided for managing email feedback. Email messages can be received via a common email address. Individual senders can be determined based on the sender addresses of the received email messages. Feedback objects can be generated and saved from the received email messages. Processing of received email messages, including reply emails, can be performed based on whether sender addresses are authorized. Feedback objects can be provided for review and management. Individual senders can log in to a system to review and manage feedback objects, including assigning classifications to feedback objects.

### BACKGROUND

Tracking and managing email feedback can be difficult and time consuming. For example, users often receive email messages that they want to save for later use for a particular reason, such as to use during job performance reviews. In addition, users often receive email messages in different locations and using different email accounts, such as at home and at work.

Users can create email folders to save the email messages. However, users may have difficulty organizing email messages and identifying which email messages are relevant to a particular goal. In addition, users may not have the email folders available when needed. For example, the email folders could be scattered between different systems, such as home and work systems. Furthermore, the user may not be able to easily share the email messages with others, such as the user's manager.

Therefore, there exists ample opportunity for improvement in technologies related to managing email feedback.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

For example, a method can be provided for managing email feedback. The method comprises receiving an email message, where the email message is addressed to a common email address, determining, based on a sender address of the received email message, an identity of an individual sender of the received email message, generating a feedback object from the received email message, and saving the feedback object, where the saved feedback object is associated with the individual sender.

As another example, a method can be provided for managing email feedback. The method comprises receiving an email message, where the email message is addressed to a common email address associated with an organization, determining, based on a sender address of the received email message, an identity of an individual sender of the received email message, determining whether the sender address is authorized to provide the email message, and when the sender address is authorized to provide the email message: sending a reply email to the individual sender indicating that the email message was successfully received, generating a feedback object from the received email message, and saving the feedback object, where the saved feedback object is associated with the individual sender. The feedback object may only accessible by the individual sender, or the feedback object may be accessible to others (e.g., when the individual sender assigns a classification to the feedback object).

As another example, a method can be provided for managing email feedback. The method comprises receiving an email message, where the email message is addressed to a common email address, and where the common email address is associated with a business reason, determining, based on a sender address of the received email message, an identity of an individual sender of the received email message, generating a feedback object from the received email message, and saving the feedback object, where the saved feedback object is associated with the individual sender, and where the email message is received as a forwarded email message from the individual sender.

As described herein, a variety of other features and advantages can be incorporated into the technologies as desired.

### BRIEF DESCRIPTION OF THE DRAWINGS

FIG. 1 is a diagram depicting an example environment for managing email feedback, including receiving and processing emailed feedback.

FIG. 2 is a flowchart of an example method for receiving email feedback.

FIG. 3 is a flowchart of an example method for receiving email feedback and determining whether a sender address is authorized.

FIG. 4 is a diagram depicting an example reply email message.

FIG. 5 is a diagram depicting an example environment for managing email feedback, including viewing and assigning feedback objects.

FIG. 6 is a diagram depicting an example graphical user interface displaying feedback objects.

FIG. 7 is a diagram depicting an example graphical user interface displaying feedback object detail.

FIG. 8 is a diagram of an example computing system in which some described embodiments can be implemented.

FIG. 9 is an example cloud computing environment that can be used in conjunction with the technologies described herein.

### DETAILED DESCRIPTION

### Example 1

### Overview

The following description is directed to techniques and solutions for managing email feedback, including forwarded email messages containing feedback. For example, an organization (e.g., a business, association, etc.) can provide a common email address that serves a plurality of users (e.g., employees) associated with the organization. In some implementations, the common email address is a single email address serving users (e.g., employees) of the organization. An example of a common email address is: feedback@organization.com.

When a user receives an email message containing feedback (email feedback or emailed feedback), the user can forward the email to the common email address. For example, the user may be working on a project for a customer of the organization. The customer can send an email to the user containing feedback regarding the project. The user can then forward to the email to the common email address.

Forwarding email feedback can be a quick and efficient way of managing feedback. For example, users can forward feedback from any email account, regardless of whether the email account is a work email account or a personal email account. For example, a user might receive email feedback via the user's personal email account and/or via the user's business email account. Regardless of the email account, the user can forward the feedback to a common feedback email address.

In addition, users can forward feedback from any email client. For example, a user may be using a webmail client at home. If the user receives an email with feedback relevant to the user's job, the user can forward the email to a common feedback email address at the user's work. The user can then log into a work system to manage the feedback (e.g., assign the feedback to a performance goal, share the feedback with others, etc.).

### Example 2

### Common Email Address

In any of the examples herein, one or more common email addresses are provided by an organization (e.g., a business) to receive feedback from people associated with the organization (e.g., individual users, such as employees, owners, contractors, etc.). A common email address is not tied to any specific individual. Instead, a common email address provides a shared address for receiving feedback forwarded from any number of people associated with the organization.

In some implementations, a common email address is associated with a business reason. For example, the business reason can be for receiving feedback related to the employees of the organization (e.g., feedback@organiation.com). Common email addresses can be provided for other reasons as well. For example, a common email addresses can be provided for an activity associated with the organization, such as a conference being managed by the organization (e.g., conference2012@organization.com).

A common email address can receive email from one or more users of an organization (e.g., from one or more employees). For example, a single common email address can be provided for an organization for receiving feedback forwarded from all users (e.g., all employees) of the organization.

### Example 3

### Determining the Identity of Individual Senders

In any of the examples herein, an individual sender of a received email message can be determined. For example, a list of individuals and their associated email addresses can be maintained. When an email message addressed to a common email address is received, the sender of the email message can be determined based on the sender email address. From the sender email address, the identity of the individual sender can be determined.

A person associated with an organization may have a number of email addresses, such as one or more work email addresses and/or one or more personal email addresses. An organization can maintain a list of individuals associated with the organization along with their work and/or personal email addresses. When receiving an email message addressed to a common email address, the sender address can be checked to see if it matches an email address in the list, and the individual associated with the email address can be determined (e.g., by name, employee identification number, etc.).

### Example 4

### Environment for Receiving Emailed Feedback

In any of the examples herein, a computing environment can be provided for managing feedback, including receiving and processing emailed feedback. For example the computing environment can be a server environment operated by an organization, such as a human resources system of a business.

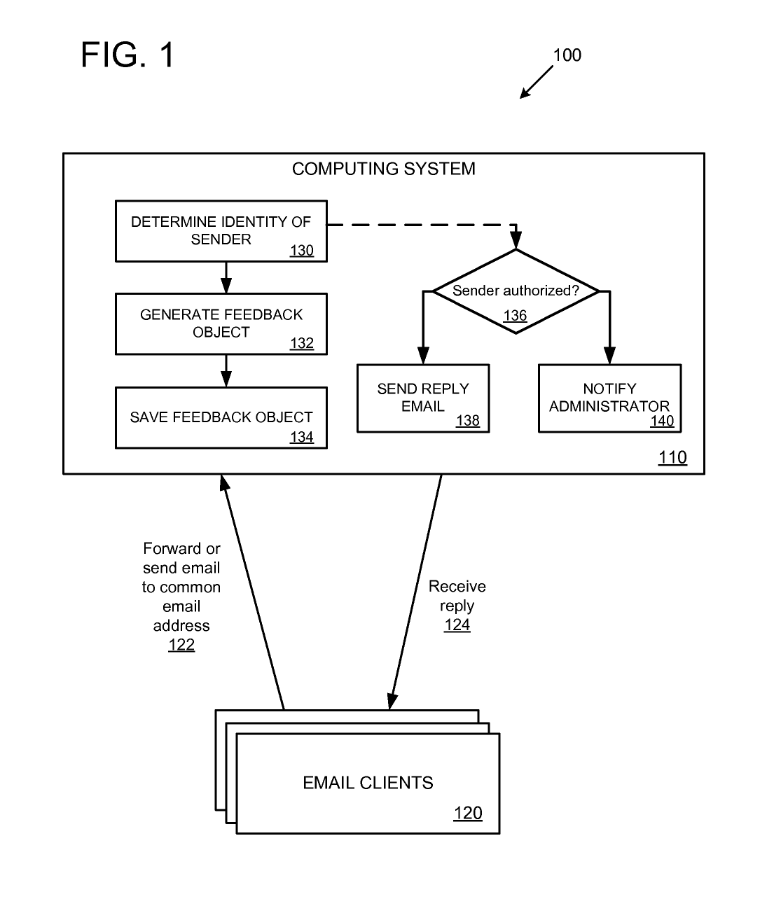

FIG. 1 is a diagram depicting an example environment 100 for managing forwarded email feedback. The environment 100 comprises a computing system 110. For example, the computing system 110 can be a server system operated by an organization (e.g., a business computing system providing computing services to employees). The computing system 110 can comprise various types of computing devices, such as computer servers, web servers, data storage systems, cloud computing resources, networking resources, etc. The computing system 110 provides services for managing email feedback.

The environment 100 includes one or more email clients 120. The email clients 120 are operated by users associated with the computing system 110 (e.g., by employees of an organization that operates the computing system 110). The email clients 120 can be email clients local to the organization (e.g., email systems used by employees of the organization) and/or email clients external to the organization (e.g., personal email clients, such as webmail clients).

The computing system 110 maintains information describing users associated with the organization and their email addresses (email accounts). For example, a user of the organization may have multiple email addresses, which can include email addresses provided by the organization (e.g., business email addresses) and/or email addresses that are not provided by the organization (e.g., personal email addresses).

Users of the computing system 110 send or forward email messages (e.g., comprising feedback) to the computing system 110 using the email clients 120. For example, an individual user can receive an email message comprising feedback regarding the individual's job performance. The individual can forward 122 the email message via an email client (one of the email clients 120) to a common email address. The computing system 110 can receive and process the received email message.

Below is an example email message that could be received by an individual user. The below example email message is received by Mark Johnson (the individual user) from Diana Greer, and contains feedback from Diana Greer regarding a marketing project.

```
From: Diana Greer <diana@company.com>
Sent: Sunday, July 8, 2012
To: Mark Johnson <mark@organization.com>
Subject: Feedback on marketing project
Body:
  Hi Mark,
  Thank you for your hard work on the project.
  Regards,
  Diana
```

After receiving the above example feedback email message, Mark Johnson can decide to forward the feedback email message to a common email address for Mark's company (e.g., to be used later during a yearly performance review). In the below example email message, Mark is forwarding the feedback email from Diana to the common email address for the organization, in this example feedback@organization.com.

```
To: feedback@organization.com
Cc:
Subject: FW: Feedback on marketing project
Attached: Well Done.pdf (101KB)
Body:
  ------ Forwarded message ------
  From: Diana Greer <diana@company.com>
  Sent: Sunday, July 8, 2012
  To: Mark Johnson <mark@organization.com>
  Subject: Feedback on marketing project
  Hi Mark,
  Thank you for your hard work on the project.
  Regards,
  Diana
```

The computing system 110 can receive and process email messages addressed to one or more common email addresses. For example, the computing system 110 can perform operations to determine the identity of an individual sender 130 of a received email message. The identity of the sender can be determined from the sender (or from) address of the email message (e.g., From: user@organization.com). The computing system 110 can generate a feedback object 132 from the received email message. The computing system 110 can save the feedback object 134 (e.g., for later management by the individual sender).

In some implementations, the computing system 110 determines whether the sender is authorized 136. For example, the computing system 110 can check whether the sender address of the received email message is associated with a user (e.g., an employee) of the organization. If the sender address is recognized, then the computing system 110 can send a reply email 138, which can then be received by the sender 124. If the sender address is not recognized, then appropriate action can be taken, such as notifying an administrator 140. The administrator can determine whether the sender address should be added to the system (e.g., associated with an employee of the organization) or ignored (e.g., because the email message is fraudulent, spam, etc.).

The computing system 110 can also perform other processing when receiving email messages addressed to a common email address. For example, the computing system 110 can perform spam filtering, anti-virus filtering, etc.

### Example 5

### Methods for Managing Email Feedback

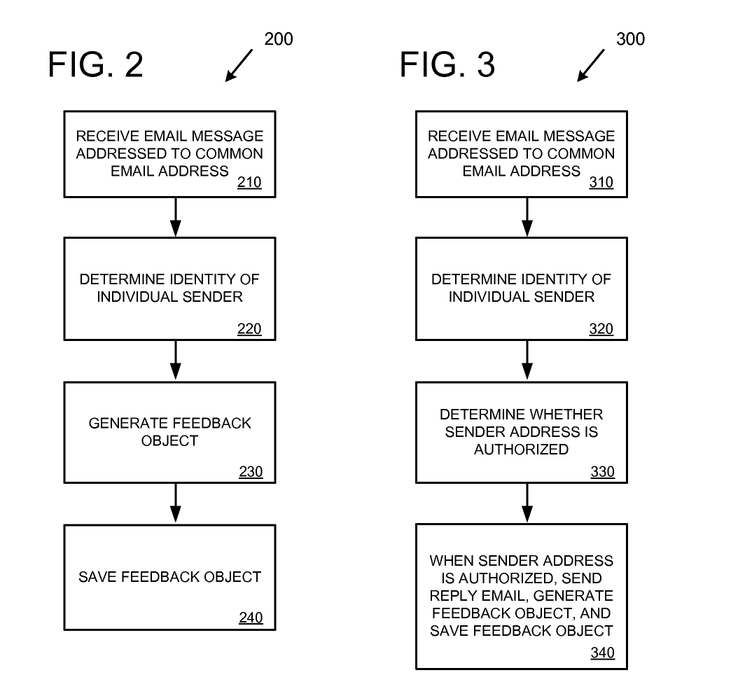

In any of the examples herein, methods can be provided for managing email feedback (e.g., forwarded email messages comprising feedback). FIG. 2 is a flowchart of an example method 200 for managing email feedback. The example method 200 can be performed, at least in part, by a computing device. For example, the example method 200 can be implemented by a computing system of an organization, such as computing system 110 depicted in FIG. 1.

At 210, an email message addressed to a common email address is received. The common email address can be associated with a business reason (e.g., feedback related to job performance, conference information, etc.). The common email address can be a single email address (e.g., feedback@ organization.com) for an organization for receiving emailed feedback forwarded to the common email address from a plurality of individuals associated with the organization (e.g., usable by all employees of the organization).

At 220, the identity of an individual sender (e.g., name, employee email address, employee identification number, etc.) of the received email message is determined. For example, the identity of the individual sender can be determined based on a sender address of the received email message. In some implementations, an organization maintains a list of individuals and their associated email addresses. By looking up the sender address in the list, the individual sender can be identified.

At 230, a feedback object is generated from the received email message. The feedback object comprises information associated with the received email message. For example, the feedback object can comprise some or all of the following information: an indication of a subject of the received email message, an indication of body text of the received email message, an indication of attachments of the received email message, an indication of the identity of the individual sender of the received email message, and/or other information (e.g., an indication of the original email message content, and indication of the recipient of the feedback, etc.).

At 240, the feedback object is saved. For example, the feedback object can be associated with the individual sender for later use by the individual sender (e.g., to assign the feedback object to a goal, activity, etc.).

FIG. 3 is a flowchart of an example method 300 for managing email feedback, including determining whether a sender address is authorized. The example method 300 can be performed, at least in part, by a computing device. For example, the example method 300 can be implemented by a computing system of an organization, such as computing system 110 depicted in FIG. 1.

At 310, an email message addressed to a common email address is received. The common email address can be associated with a business reason (e.g., feedback related to job performance, conference information, etc.). The common email address can be a single email address (e.g., feedback@ organization.com) for an organization for receiving emailed feedback forwarded to the common email address from a plurality of individuals associated with the organization.

At 320, the identity of an individual sender (e.g., name, employee email address, employee identification number, etc.) of the received email message is determined. For example, the identity of the individual sender can be determined based on a sender address of the received email message.

At 330, a determination is made indicating whether the sender address is authorized. For example, the sender address can be checked against records of individuals associated with the organization and their various email addresses. If the sender address is found, then the sender address is authorized. Otherwise, if the sender address is not found, then the sender address is not authorized.

At 340, when the sender address is authorized (e.g., when the sender address is assigned to an individual sender, such as an employee, associated with the organization), a reply email is sent to the individual sender (e.g., indicating that the email message was successfully received and processed), a feedback object is generated from the received email message, and the feedback object is saved (e.g., for later management by the individual user). When the sender is not authorized (e.g., when the sender address is not assigned to any individual sender associated with the organization), a reply email is not sent and no feedback object is generated. When the sender is not authorized, an administrator can be notified (e.g., the administrator can check to see whether the sender address should be added to a list of authorized senders and associated with an individual of the organization).

### Example 6

### Reply Emails

In any of the examples herein, an individual sender that forwards an email message to a common email address can receive a reply email indicating that the forwarded email message was successfully received and processed.

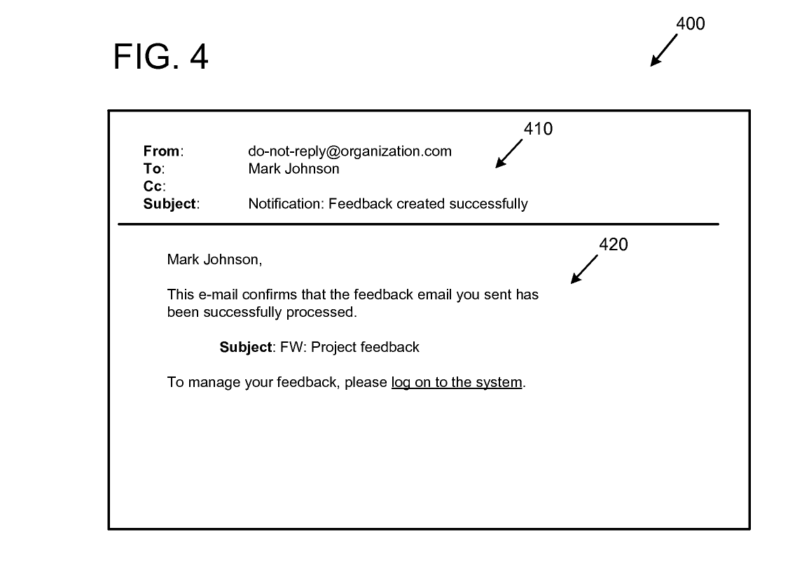

FIG. 4 depicts an example reply email message 400. The reply email message 400 is received by an individual sender (Mark Johnson) in response to the individual sender forwarding a feedback email to a common email address (e.g., feedback@ organization.com). The reply email message 400 includes a header portion 410 and a body portion 420. As indicated by the reply email message 400, the individual sender (Mark Johnson) forwarded a feedback email with the subject (FW: Project feedback) which has been successfully processed (e.g., a feedback object was created and stored).

The example reply email message 400 can be received when (e.g., only when) the sender address is authorized. For example, individual sender Mark Johnson can forward a feedback email message. The email message can be received and the sender address (e.g., mark.johnson@organization) checked to see if it is authorized. When it is authorized, the reply email message 400 can be sent back to the sender address (e.g., back to mark.johnson @organization.com).

The reply email message 400 also includes a link that the user can click to log on to a system to manage the feedback. For example, the user can select the link to log in to a business system viewing feedback objects and assigning feedback objects to performance goals.

### Example 7

### Environment for Viewing and Assigning Feedback Objects

In any of the examples herein, a computing environment can be provided for managing feedback, including viewing and assigning feedback objects. For example the computing environment can be a server environment operated by an organization, such as a human resources system of a business.

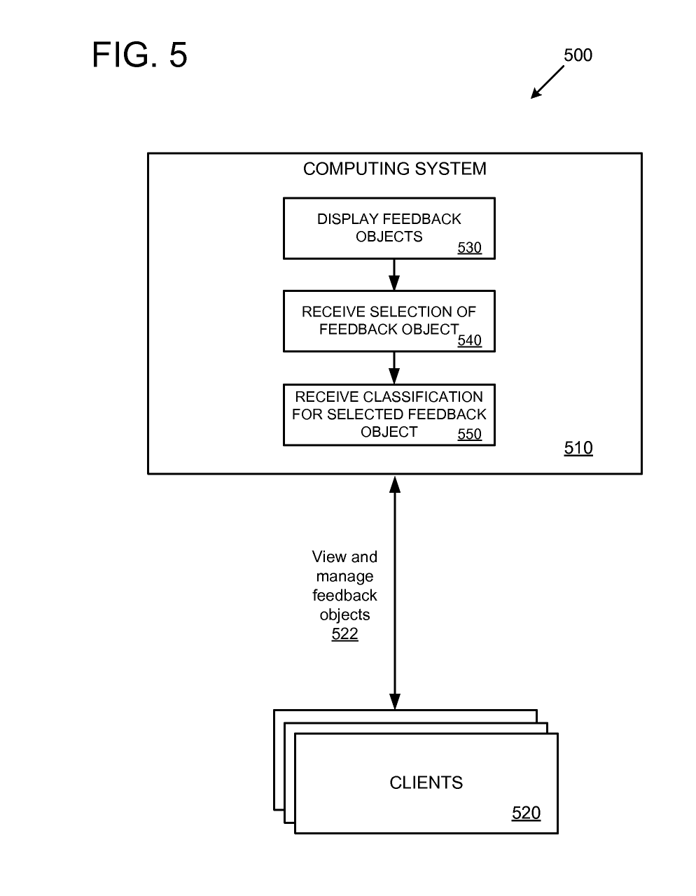

FIG. 5 is a diagram depicting an example environment 500 for managing feedback, including viewing and assigning classifications to feedback objects. The environment 500 comprises a computing system 510. For example, the computing system 510 can be a server system operated by an organization (e.g., a business computing system providing computing services to employees). The computing system 510 can comprise various types of computing devices, such as computer servers, web servers, data storage systems, cloud computing resources, networking resources, etc. The computing system 510 provides services for managing email feedback.

Clients 520 (e.g., individual users, such as employees) can use the computing system 510 to manage email feedback. For example, the clients 520 can use the computing system 510 to view and manage feedback objects 522 (e.g., feedback objects generated from forwarded email feedback). The clients 520 can be located internally (e.g., internal to the organization) or externally (e.g., accessing the computing system 510 via a web service).

For example, an individual client (e.g., one of the clients 520) can log into the computing system 510. The computing system 510 can display a list of feedback objects associated with the individual client (e.g., feedback objects that have been generated from email feedback received from the individual client).

In some implementations, the feedback objects associated with an individual client (individual sender) are only accessible to the individual, and not to other users of the organization (e.g., other employees or managers). In some implementations, accessibility to the feedback objects associated with an individual can be changed. For example, a setting (e.g., a privacy setting) associated with a feedback object can indicate who has access to the feedback object. Initially, the feedback object can be set to only allow access by the associated individual. Later (e.g., when the individual has assigned a classification to the feedback object, when the individual would like to use the feedback in a performance review, or for another reason), the feedback object can be set to also allow access by others (e.g., by a manager).

The computing system 510 can perform operations for managing feedback, including viewing and assigning feedback objects. For example, the computing device 510 can display feedback objects 530 to individual clients, receive a selection of a feedback object 540 from the displayed feedback objects, and receive a classification for the selected feedback object 550 (e.g., for assigning the feedback object to a performance goal).

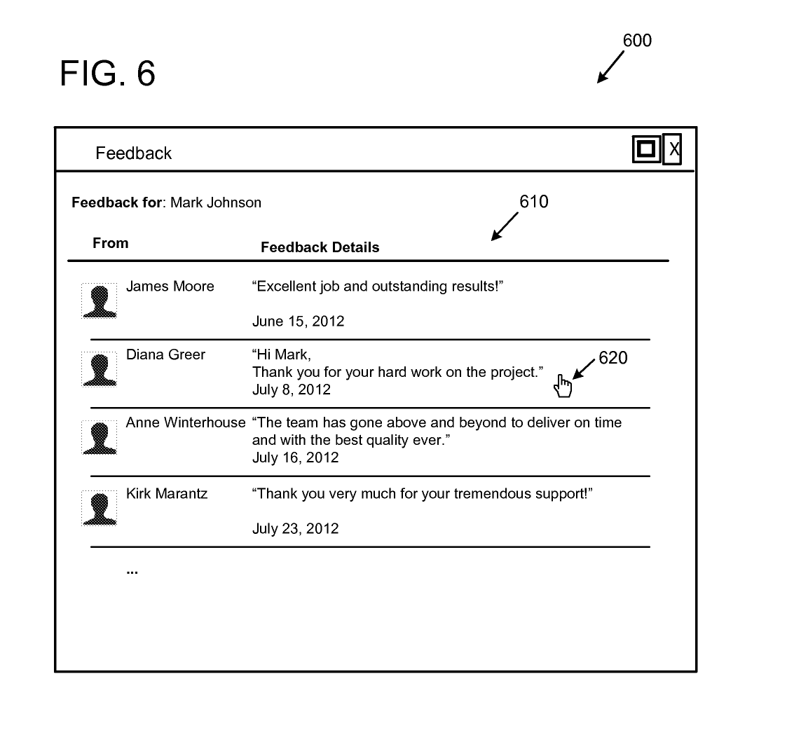

FIG. 6 is a diagram depicting an example graphical user interface 600 displaying feedback objects for a specific user. In the example user interface 600, the specific user is Mark Johnson (the individual sender of the forwarded email feedback).

In the example user interface 600, feedback objects 610 associated with the specific user Mark Johnson are displayed. The feedback objects 610 were generated from email feedback messages forwarded by Mark Johnson. The feedback objects 610 can be displayed, for example, in a list format (as depicted at 610) or in a different type of format or layout (e.g., grouped by the person that provided the feedback).

In the example user interface 600, each of the feedback objects 610 is displayed with information about the person providing the feedback (name and picture) and details about the feedback (text content and date). Instead of, or in addition to, the displayed feedback information, other information could be displayed (e.g., information regarding attachments, subject, assigned goals, whether the feedback object is private or accessible to others, etc.).

In the example user interface 600, a user (e.g., Mark Johnson) can select a feedback object. For example, the user can select a feedback object to view additional information about the feedback object, to assign the feedback object to a goal, to manage settings for the feedback object (e.g., privacy settings), to delete the feedback object, etc. In the example user interface 600, the user has selected the feedback object representing feedback from Diana Greer, as indicated by the selection icon 620.

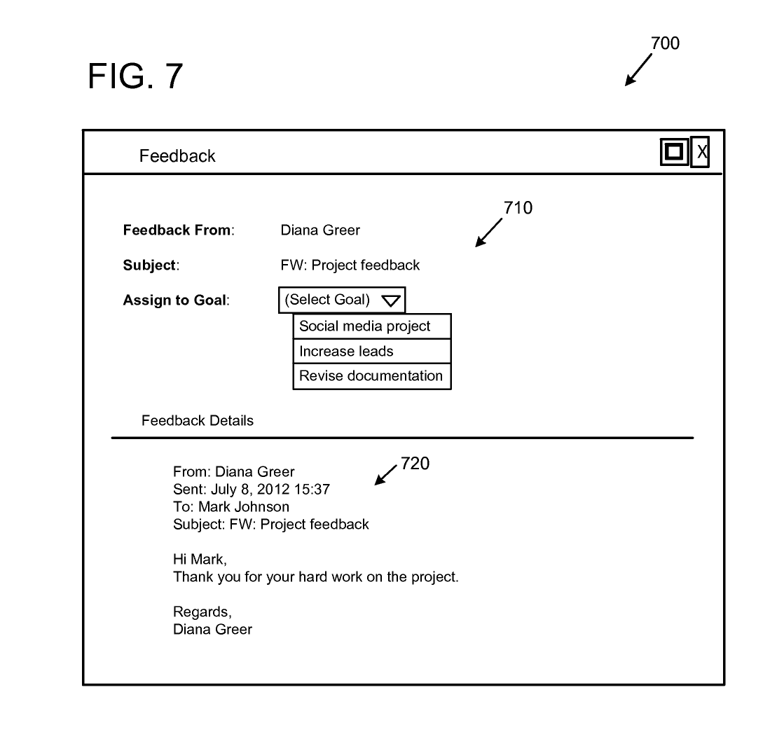

FIG. 7 is a diagram depicting an example graphical user interface 700 displaying feedback object detail for a selected feedback object (in this example, the selected feedback object 620 from FIG. 6). The displayed feedback object detail includes information indicating the person who provided the feedback, the subject of the feedback, and a user interface element for classifying the feedback object by assigning the feedback object to a goal 710. The displayed feedback object detail also includes information about the original forwarded feedback email 720.

A user of the example user interface 700 can assign the feedback object to a goal 710. For example, a list of available job performance goals can be displayed. The user can assign the feedback object to one or more of the listed goals. Feedback objects assigned to one or more of the goals can be used, for example, during the user's performance review. In some implementations, when a feedback object is assigned to a goal it is made accessible (e.g., automatically made accessible) to a manager or managers.

The example user interface 700 can provide other options for managing the feedback object. For example, a user interface element can be provided for sharing the feedback object (e.g., sharing the feedback object with a work group) or for forwarding the feedback object to another user.

### Example 8

### Example Implementation

This section describes an example implementation and usage scenario for the technology described herein. One or more of the techniques described in this section can be combined with techniques described elsewhere herein.

In the example implementation, a user receives information by email that is relevant for a business application (e.g., feedback related to a project that the user is in charge of). In order to have the information available in the business system (e.g., available for use within the user's business, such as a career system and/or human resources (HR) system), the user forwards the email to the business system (e.g., to a common email address provided by the business system). The user can forward the email from the user's email client (e.g., a business email client, a webmail client, etc.) without the user having to log into a different system or launch a different application. For example, if the user receives an email from a customer with good customer feedback, the user can forward it to the common email address in order to have the email available for job performance discussions with the user's manager.

The common email address is a single email address for a business reason (e.g., a single email address for feedback, a single email address for conference planning, etc.). A number of users (e.g., employees) can use the same single email address.

The business system processes incoming email feedback. First, the business system determines the user/employee that sent (e.g., forwarded) the email message. The business system can determine the user from the sender address of the email. Second, the business system creates information (e.g., a feedback object) describing the email message, such as subject, body, attachments, the person that provided the feedback to the user, etc. Optionally, the business system sends a reply email indicating the email was successfully received and processed.

The business system also provides security. To maintain security, the business system only sends reply emails to sender email addresses that have been assigned to users (e.g., employees) within the business system. If a sender address is not recognized (e.g., not assigned to a user), an administrator is notified. The administrator can take appropriate action (e.g., assign the sender address to a user, block future emails from the sender address, discard the email, etc.). The business system can also provide spam filtering and/or virus checking for incoming email messages.

The user can log into the business system to manage the email information (e.g., feedback objects). For example, the user can assign feedback to a performance goal, share the feedback with others, delete the feedback, etc.

### Example 9

### Computing Systems

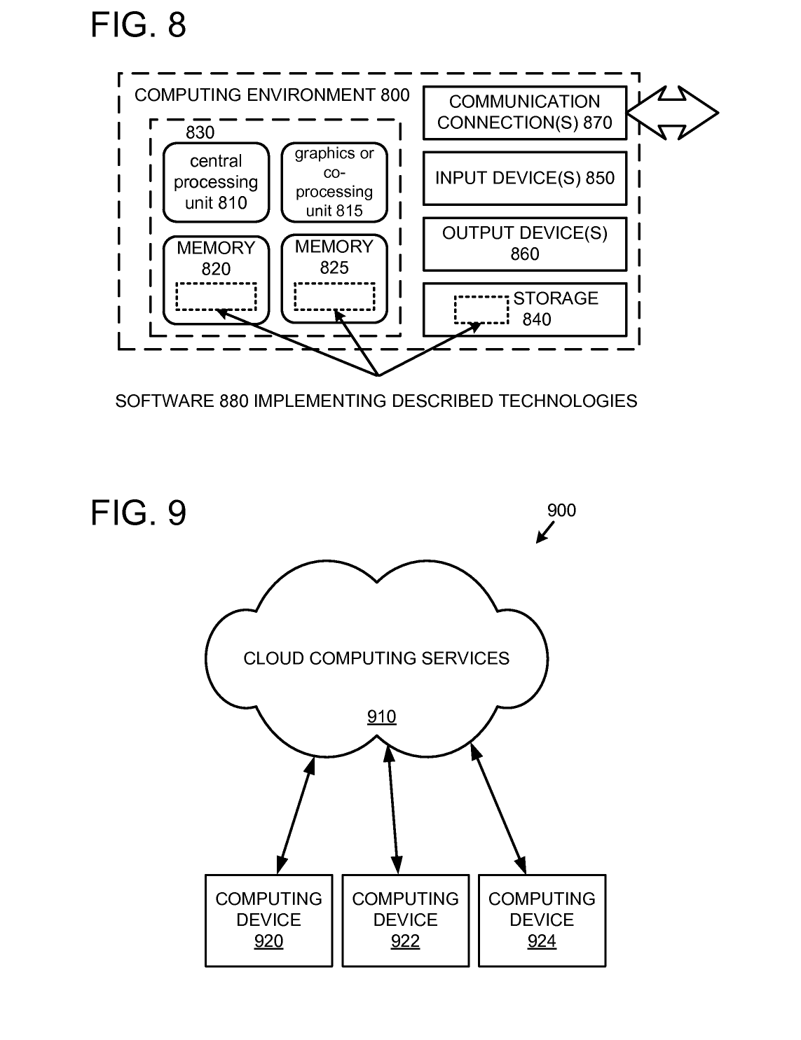

FIG. 8 depicts a generalized example of a suitable computing system 800 in which the described innovations may be implemented. The computing system 800 is not intended to suggest any limitation as to scope of use or functionality, as the innovations may be implemented in diverse general-purpose or special-purpose computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s). The memory 820, 825 stores software 880 implementing one or more innovations described herein, in the form of computer-executable instructions suitable for execution by the processing unit(s).

A computing system may have additional features. For example, the computing system 800 includes storage 840, one or more input devices 850, one or more output devices 860, and one or more communication connections 870. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 may be removable or non-removable, and includes magnetic disks, magnetic tapes or cassettes, CD-ROMs, DVDs, or any other medium which can be used to store information in a non-transitory way and which can be accessed within the computing system 800. The storage 840 stores instructions for the software 880 implementing one or more innovations described herein.

The input device(s) 850 may be a touch input device such as a keyboard, mouse, pen, or trackball, a voice input device, a scanning device, or another device that provides input to the computing system 800. For video encoding, the input device(s) 850 may be a camera, video card, TV tuner card, or similar device that accepts video input in analog or digital form, or a CD-ROM or CD-RW that reads video samples into the computing system 800. The output device(s) 860 may be a display, printer, speaker, CD-writer, or another device that provides output from the computing system 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 10

### Cloud Computing Environment

FIG. 9 depicts an example cloud computing environment 900 in which the described technologies can be implemented. The cloud computing environment 900 comprises cloud computing services 910. The cloud computing services 910 can comprise various types of cloud computing resources, such as computer servers, data storage repositories, networking resources, etc. The cloud computing services 910 can be centrally located (e.g., provided by a data center of a business or organization) or distributed (e.g., provided by various computing resources located at different locations, such as different data centers and/or located in different cities or countries).

The cloud computing services 910 are utilized by various types of computing devices (e.g., client computing devices), such as computing devices 920, 922, and 924. For example, the computing devices (e.g., 920, 922, and 924) can be computers (e.g., desktop or laptop computers), mobile devices (e.g., tablet computers or smart phones), or other types of computing devices. For example, the computing devices (e.g., 920, 922, and 924) can utilize the cloud computing services 910 to perform computing operators (e.g., data processing, data storage, and the like).

### Example 11

### Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., non-transitory computer-readable media, such as one or more optical media discs such as DVD or CD, volatile memory components (such as DRAM or SRAM), or nonvolatile memory components (such as flash memory or hard drives)). By way of example and with reference to FIG. 8, computer-readable storage media include memory 820 and 825, and storage 840. The term computer-readable storage media does not include communication connections (e.g., 870) such as modulated data signals or carrier waves.

Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method, implemented at least in part by a computing device, for managing email feedback, the method comprising:
by the computing device:
receiving an email message, wherein the email message is addressed to a common email address, wherein the common email address is associated with a business reason;
determining, based on a sender address of the received email message, an identity of an individual sender of the received email message;
generating a feedback object from the received email message; and
saving the feedback object, wherein the saved feedback object is associated with the individual sender.

2. The method of claim 1, wherein the feedback object comprises:
an indication of a subject of the received email message;
an indication of body text of the received email message;
an indication of attachments of the received email message; and
an indication of the identity of the individual sender of the received email message.

3. The method of claim 1, further comprising:
determining that the sender address is authorized to provide the email message;
wherein the generating the feedback object and the saving the feedback object are performed responsive to determining that the sender address is authorized.

4. The method of claim 3, further comprising:
in response to determining that the sender address is authorized, sending a reply email to the individual sender indicating that the email message was successfully received.

5. The method of claim 1, wherein the common email address is a single email address for an organization for receiving emailed feedback forwarded to the common email address from a plurality of individuals associated with the organization.

6. The method of claim 1, further comprising:
displaying, to the individual sender, a graphical user interface depicting the feedback object; and
receiving, from the individual sender, a selection of a classification for the feedback object.

7. The method of claim 6, wherein the selection of the classification comprises a selection of a performance goal from a plurality of available performance goals.

8. The method of claim 6, further comprising:
in response to receiving the selection of the classification, changing a setting for the feedback object to make the feedback object visible to one or more individuals other than the individual sender.

9. The method of claim 1, wherein the common email address is a single email address for an organization, wherein the individual sender is an employee of the organization, wherein the email message is received by the organization in response to the user forwarding the email message to the common email address, and wherein the email message contains feedback related to the employee's job.

10. The method of claim 1, further comprising:
performing one or more of virus checking and spam filtering for the received email message.

11. A system comprising:
memory;
a processing unit; and
one or more computer-readable storage media storing instructions causing the system to perform operations for managing email feedback, the operations comprising:
receiving an email message, wherein the email message is addressed to a common email address associated with an organization;
determining, based on a sender address of the received email message, an identity of an individual sender of the received email message;
determining whether the sender address is authorized to provide the email message; and
when the sender address is authorized to provide the email message:
sending a reply email to the individual sender indicating that the email message was successfully received;
generating a feedback object from the received email message; and
saving the feedback object, wherein the saved feedback object is associated with the individual sender;
wherein the feedback object is only accessible by the individual sender.

12. The system of claim 11, the operations further comprising:
when the sender address is not authorized to provide the email message:
notifying an administrator that the email message has been received from a sender address that is not authorized.

13. The system of claim 11, wherein the feedback object comprises:
an indication of a subject of the received email message;
an indication of body text of the received email message;
an indication of attachments of the received email message; and
an indication of the identity of the individual sender of the received email message.

14. The system of claim 11, wherein the common email address is a single email address for an organization for receiving emailed feedback forwarded to the common email address from a plurality of individuals associated with the organization.

15. The system of claim 11, the operations further comprising:
displaying, to the individual sender, a graphical user interface depicting the feedback object; and
receiving, from the individual sender, a selection of a classification for the feedback object.

16. The system of claim 15, wherein the selection of the classification comprises a selection of a performance goal from a plurality of available performance goals.

17. The system of claim 15, the operations further comprising:
in response to receiving the selection of the classification, changing a setting for the feedback object to make the feedback object visible to one or more individuals other than the individual sender.

18. The system of claim 11, wherein the common email address is a single email address for an organization, wherein the individual sender is an employee of the organization, wherein the email message is received by the organization in response to the user forwarding the email message to the common email address, and wherein the email message contains feedback related to the employee's job.

19. One or more computer-readable storage media storing computer-executable instructions for causing a computing device to perform a method for managing email feedback, the method comprising:
receiving an email message, wherein the email message is addressed to a common email address, wherein the common email address is associated with a business reason;
determining, based on a sender address of the received email message, an identity of an individual sender of the received email message;
generating a feedback object from the received email message; and
saving the feedback object, wherein the saved feedback object is associated with the individual sender;
wherein the email message is received as a forwarded email message from the individual sender.

20. The one or more computer-readable storage media of claim 19, the method further comprising:
determining that the sender address is authorized to provide the email message;
wherein the generating the feedback object and the saving the feedback object are performed responsive to determining that the sender address is authorized.
